(19) United States
(12) Patent Application Publication
(10) Pub. No.: US 2026/0104053 A1
(43) Pub. Date: Apr. 16, 2026

(54) FAN AND COOLING STRUCTURE FOR A FAN

(71) Applicant: ZIEHL-ABEGG SE, Künzelsau (DE)

(72) Inventors: Frieder LOERCHER, Braunsbach (DE); Sven LOENNE, Obersulm (DE); Matthias STAHL, Krautheim-Oberndorf (DE); Daniel SEIFRIED, Rosengarten (DE)

(21) Appl. No.: 19/117,202

(22) PCT Filed: Sep. 21, 2023
(86) PCT No.: PCT/DE2023/200195

§ 371 Date: Mar. 31, 2025

(30) Foreign Application Priority Data
Oct. 6, 2022 (DE) 102022210555.9

(51) Int. Cl. F04D 25/08; F04D 25/06; F04D 29/58; H02K 9/10

(52) U.S. Cl. CPC F04D 25/06; F04D 19/002; F04D 29/584

(57) ABSTRACT

A fan with an impeller and an electric motor, wherein the electric motor includes a stator, a rotor and possibly an electronics pot, wherein a cooling structure is formed or provided on the outer wall radially outside the stator and/or the electronics pot, which cooling structure forms a flow path for a fluid, in an embodiment for air, by way of which a flow is induced as a consequence of a pressure difference generated by the operation of the fan, which flow dissipates heat from the electric motor and/or from the stator and/or from the electronics pot. Moreover, the disclosure relates to a corresponding cooling structure for a fan.

### CROSS REFERENCE

This application is a national stage entry application under 35 U.S.C. 371 of PCT Patent Application No. PCT/DE2023/200195 filed on 21 Sep. 2023, which claims priority to German Patent Application No. 10 2022 210 555.9, filed on 6 Oct. 2022 the entire contents of each of which are incorporated herein by reference.

### FIELD

The present disclosure relates to a fan having a particular cooling structure, and to a cooling structure, in particular for improved cooling of an electric motor due to a cooling flow induced between the cooling structure and the electric motor.

### BACKGROUND

Fans of the generic type are well known in practice. Reference is to be made merely by way of example to WO 2020/015792 A1.

Fans are typically exposed to high thermal loads, for example of ≥60° C. In particular in a “suctioning” arrangement, for example where hot air of a heat exchanger is inducted through the fan, corresponding temperatures are noticeably disadvantageous. In particular the electronics components which are located in an integrated electronics unit (in an EC fan) and other components such as bearings, insulation materials, winding wires, etc. are subject to specific temperature limits that limit the output and/or the rotating speed of the fan. Excessive temperatures lead to damage to the components.

In the prior art, there are already attempts to avoid the above-mentioned overheating issues. External rotor EC motors having integrated electronics units are thus already equipped with integrated cooling. This requires a new construction of the motor. Also, there are already hubs with breakthroughs or clearances which cause sacrifices in terms of efficiency. An improved air flow about the motor can be effected by the latter.

Also already known in practice are cooling systems having breakthroughs on the stator flange, wherein this also requires the construction of the motors, or of the stators, to be modified. Also, there are already additional components for directing cooling air to, or about, the motor. This is complex in terms of construction and detrimental to efficiency.

### SUMMARY

The present disclosure is based on the object of at least largely eliminating the issues arising in the prior art. Sufficiently positive cooling of the electric motor of the fan is to be achieved with simple means. It should also be possible to retrofit the cooling structure required for cooling, so as to improve the dissipation of heat from the motor and to minimize losses in terms of the efficiency of the fan. Moreover, the fan according to the present disclosure and the cooling structure according to the present disclosure should distinguish themselves from competing products.

The above object is achieved, in an embodiment, by the features of claim 1, according to which a cooling structure is formed or provided on the external wall radially outside the stator and/or the electronics pot. The cooling structure, conjointly with the motor, forms a flow path for a fluid, in the simplest case for ambient air. Due to the operation of the fan, a flow through this flow path is induced by way of a pressure differential. As a result, heat is dissipated away from the electric motor and/or from the stator and/or from the electronics pot. In other words, cooling is performed by dissipating heat.

The cooling structure according to the present disclosure can be implemented in many different ways. It is essential herein that the flow path does not lead through functionally relevant components of the motor. In the absence of the cooling structure, such a motor is fully functional but has a reduced cooling capability. Accordingly, the cooling structure can be retrofitted. For this purpose, the cooling structure can be formed in a particular component.

It is also conceivable that the cooling structure is integrated into a preferably cast streamer housing, and is provided by the streamer housing. Such a cooling structure comprises a pot which surrounds the motor at a radial spacing and which is passed through by a flow in a targeted manner with the aid of the flow field generated by the fan in such a way that an improved dissipation of heat from the motor takes place. Losses in terms of the efficiency of the fan can be reduced by this measure.

If the cooling structure is retrofitted, it is necessary to provide a hub pot which is enlarged in terms of its diameter in comparison to the impeller hub, wherein this enlarged hub pot should be at least 105%, and at most 130%, preferably 115%, of the size (of the diameter) of the conventional hub pot.

The cooling structure can be fastened directly or indirectly to the stator. In the state assembled with the stator, said cooling structure has at least one, and in an embodiment three, axial breakthroughs or passages in the interior of the cooling structure. These form flow paths in the axial direction, specifically from one side of the cooling structure to the axially opposite side of the cooling structure. The at least one flow path, or the plurality of flow paths, between the one side and the other side of the cooling structure are advantageously formed, with the aid of a special guiding contour, for guiding the cooling flow, said guiding contours when interacting with the external wall of the motor, or of the stator, or of the electronics housing, forming the flow paths. They extend axially along the motor, or the stator, or the electronics housing. Due to the flow field generated by the fan during operation, in particular due to the pressure differential between the two axially opposite sides of the cooling structure, “cold” ambient air flows at a relatively high velocity and with high turbulence through the flow paths within the cooling structure along the stator and/or the electronics housing, thus sufficiently positively cooling the motor and power electronics located therein.

There are various possibilities to advantageously design and refine the teaching of the present disclosure. In this context, reference is made to the claims dependent on claims 1 and 12 in various embodiments, on the one hand, and to the explanation hereunder of exemplary embodiments of a fan according to the present disclosure by means of the drawing, on the other hand. Generally design embodiments and refinements of the teaching are also explained in conjunction with the explanation of the exemplary embodiments of the present disclosure by means of the drawings.

### BRIEF DESCRIPTION OF THE DRAWINGS

FIG. 1 shows in a perspective view, when viewed from the outflow side, a fan having a cooling structure according to the present disclosure integrated into a structural streamer unit, having a housing, a streamer assembly and strut wings;

FIG. 2 shows in a perspective view, when viewed from the inflow side, the fan according to FIG. 1;

FIG. 3 shows in a flat axial top view, when viewed from the inflow side, the fan having the structural streamer unit from FIG. 1 and FIG. 2;

FIG. 4 shows in a flat axial top view, when viewed from the outflow side, the fan having the structural streamer unit from FIGS. 1 to 3;

FIG. 4a shows a detailed view from FIG. 4 in the region of the cooling structure, wherein a width dimension is schematically plotted;

FIG. 5 shows in a lateral view, and in a sectional view through a plane through the axis, the fan having the structural streamer unit according to FIGS. 1 to 4, wherein only the half above the fan axis is shown, with dimensions schematically plotted;

FIG. 5a shows a detailed view from FIG. 5 in the region of the cooling structure, wherein further characteristic dimensions are schematically plotted;

FIG. 6a shows a detailed view similar to that of FIG. 5a in the region of the cooling structure, having a further embodiment of a cooling structure with an inlet region of the cooling flow routing;

FIG. 7 shows in a flat axial top view, when viewed from the inflow side and in the form of a fragment, a cooling structure according to the present disclosure having guide elements integrated externally therein and having an integrated electric motor;

FIG. 8 shows in a perspective view, when viewed from the stator side, a further embodiment of a cooling structure for a fan having an electric motor installed therein, wherein no cooling flow routing is provided;

FIG. 9 shows in a flat axial top view, when viewed from the stator side, the cooling structure having the electric motor from FIG. 8, wherein two dimensions are schematically plotted;

FIG. 10 shows in a lateral view, and in a sectional view through a plane through the axis, the cooling structure having the electric motor from FIGS. 8 and 9;

FIG. 11 shows in a perspective view, when viewed from the outflow side, a further embodiment of a fan having a cooling structure integrated into an inner streamer assembly, wherein the support function is assumed by a metallic strut suspension and no structural streamer unit is embodied;

FIG. 12 shows in a perspective view, when viewed from the outflow side, a further embodiment of a cooling structure of a fan of a radial construction type, wherein the cooling structure is integrated into a motor support plate of a support module;

FIG. 13 shows in a lateral view and in a partially sectional view, in a region close to the cooling structure, through a plane through the axis, the cooling structure having the electric motor from FIG. 12; and

FIG. 13a shows a detailed view of FIG. 13 in the region of the cooling structure, wherein a characteristic dimension is additionally schematically plotted.

### DETAILED DESCRIPTION OF THE DISCLOSURE

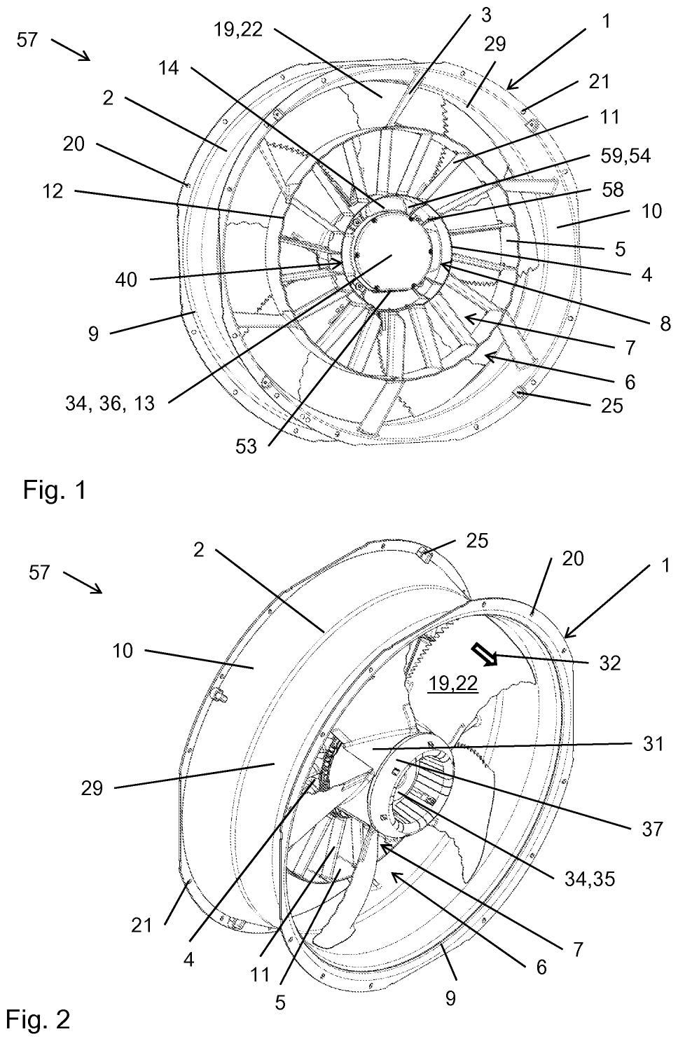

FIG. 1 shows in a perspective view, when viewed from the outflow side, a fan 57 of an axial construction type, having an exemplary embodiment of a cooling structure 40 according to the present disclosure, which is presently integrated into a structural streamer unit 1 so as to be integral to the latter. The streamer unit 1 includes in particular of a housing 2, an intermediate ring 5, a hub ring 4, inner guide vanes 11 extending between the hub ring 4 and the intermediate ring 5, and strut wings 3 extending between the intermediate ring 5 and the housing 2, or the diffusor region 10 of the latter, respectively. The streamer unit 1 may be produced integrally in a casting method, or may be produced in a plastic injection molding process.

The housing 2 defines the outer delimitation of a fan flow running within the housing 2. The housing 2 includes of various regions, when viewed in the flow direction, first of an inlet nozzle 9, then of an advantageously cylindrical region 29, in an embodiment, within which is disposed the impeller 19 with its vanes 22, and of a diffusor region 10 to which the strut wings 3 are fastened. Disposed downstream of the impeller 19, within the housing 2, is an inner streamer assembly including in particular of fluidically effective inner streamer vanes 11 which extend between the hub ring 4 and the intermediate ring 5. Due to the fluidic effect of the inner streamer vanes 11 interacting with the intermediate ring 5 and the hub ring 4, the static efficiency and the air output, especially the static pressure increase at a specific conveyed volumetric flow, of the fan 57 are particularly highly. On the hub ring 4, radially within the latter in the stator-proximal receptacle region 8, also referred to as the hub pot 8, the motor 34 with its stator 36 is fastened to a flange 54 of the cooling structure 40, said flange 54 presently also serving as a motor fastening flange 59, so that the inner streamer vanes 11 and the intermediate ring 5 also perform a structural function for the motor 36, and ultimately also for the impeller 19.

The outer strut wings 3 are provided to hold the motor 34 with the impeller 19 and the inner streamer assembly on the outer housing 2. Said outer strut wings 3 have, if any, a subordinate fluidic function and serve largely for fastening the inner streamer assembly, and thus the motor 34 and the impeller 19, to the outer housing 2. They are embodied so as to be favorable in terms of noise, so that no noise, or only very little additional noise, is generated due to their presence during the operation of the fan 57. Overall, two different flow regions, an outer flow region 6 between the intermediate ring 5 and the diffusor wall 10 of the housing 2, and an inner flow region 7 between the hub ring 4 and the intermediate ring 5, are formed within the housing 2 in the axial region of the diffusor 10 when viewed in the direction of the span (when viewed from the hub ring 4 to the diffusor 10).

The inner flow region 7 has the structural inner guide elements 11, which have a fluidic function and, for example, reduce the whirl in the flow and cause a build-up of static pressure, thus avoiding or reducing a return flow on the hub, and due to their radially inner position generate only little noise.

The outer flow region 6 has the likewise structural strut wings 3, in the exemplary embodiment 6 pieces, advantageously 4 to 8 pieces, in an embodiment, distributed across the circumference, which are embodied so as to be optimized in terms of noise. Flanges are integrally embodied on the structural streamer unit 1, on the inflow-side and outflow-side peripheral regions of the housing 2, said flanges advantageously having various fastening provisions.

On the inflow-side flange, there are fastening provisions 20 for fastening the streamer unit 1 and thus the fan 57 to a superordinate apparatus or system; likewise, fastening provisions 21 for fastening the streamer unit 1 to a superordinate apparatus or system are embodied on the outflow-side flange.

Furthermore provided on the outflow-side flange are fastening provisions 25 for a touch-protection mesh, which can also be provided in a similar way on the inflow-side flange. The touch-protection meshes can be screwed to the region 25 so as to be recessed in such a way that they do not project axially beyond the streamer unit 1, this leading to a positive handling capability and to a positive stack ability of the fans 57.

The intermediate ring 5 on its outflow-side periphery 12 is embodied so as to be undulated and may also be embodied so as to be serrated or slotted. However, said intermediate ring 5 may also be embodied so as to be circular without any undulation.

Within the hub ring 4, in the stator-proximal receptacle region 8, the motor is fastened to the structural streamer assembly 1 on an integrally attached motor support flange 59, the latter presently simultaneously being the flange 54 of the cooling structure. Reinforcement ribs 58 for reinforcing and stabilizing the connection to the motor are also attached within the stator-proximal receptacle region 8. In particular, provisions for improving the dissipation of heat from the motor are provided in the stator-proximal receptacle region 8, for example cooling flow guides 14 which can be seen here.

Formed on the fan shown is a cooling structure 40 which in the exemplary embodiment is integrated into the structural streamer unit 1 so as to be integral to the latter. During the operation of the fan 57, the cooling structure 40 is passed through by a cooling flow which dissipates an additional heat flow from the motor 34, or from the stator 36, or from the electronics pot 13, respectively. Said cooling structure 40 in the exemplary embodiment includes the hub ring 4 and the elements which are integrally attached radially within the latter, in particular the cooling structure flange 54, presently also embodied as the motor support flange 59, having a special design which will yet be described in more detail by means of further illustrations, and advantageously furthermore includes the cooling flow guides 14, as in the exemplary embodiment shown.

It is conceivable that replaceable inserts are provided in the region within the hub ring 4, thus in the stator-proximal receptacle region 8, in the molding tool for producing the structural streamer unit 1, so as to implement different interfaces to different motors and/or different embodiments of the cooling structure 40 which is presently produced so as to be integral to the structural streamer assembly 1. Apart from the pitch circle for fastening the motors, also the axial screw plane for the motor, i.e. the axial position of the cooling structure flange/motor support flange 54, 59, may vary within the receptacle region 8, for example. The presence or the design of the cooling flow guides 14 can also vary.

Of the motor 34, which is presently an external rotor motor and is furthermore advantageously embodied as an EC motor, advantageously having an integrated motor electronics unit, the stator 36 can be seen. Formed in the stator 36 is a motor electronics unit in an integrated electronics pot/electronics housing 13. An electronics pot/electronics housing can also be fastened as a separate component to a stator. In terms of its functional mode, the cooling structure 40 facilitates the dissipation of waste heat from the stator 36 of the motor 34, and in the exemplary embodiment in particular from the electronics pot 13 of the latter. As a result, electronic components are better cooled, and the motor can achieve higher torques and thus higher outputs at identical ambient temperatures or conveying means temperatures.

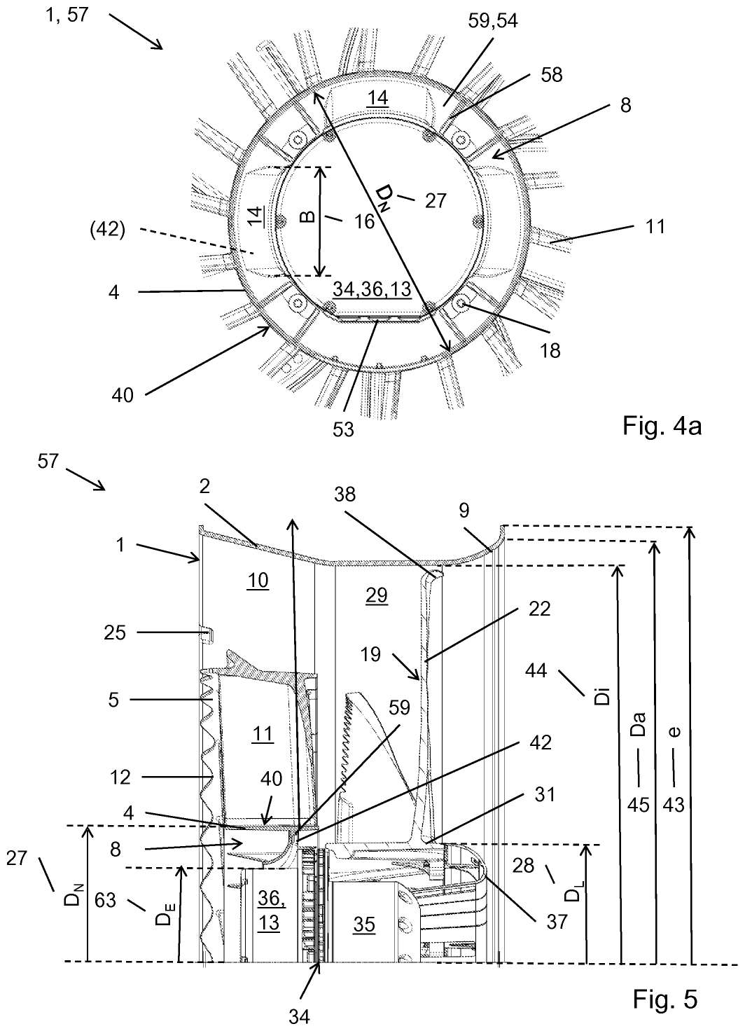

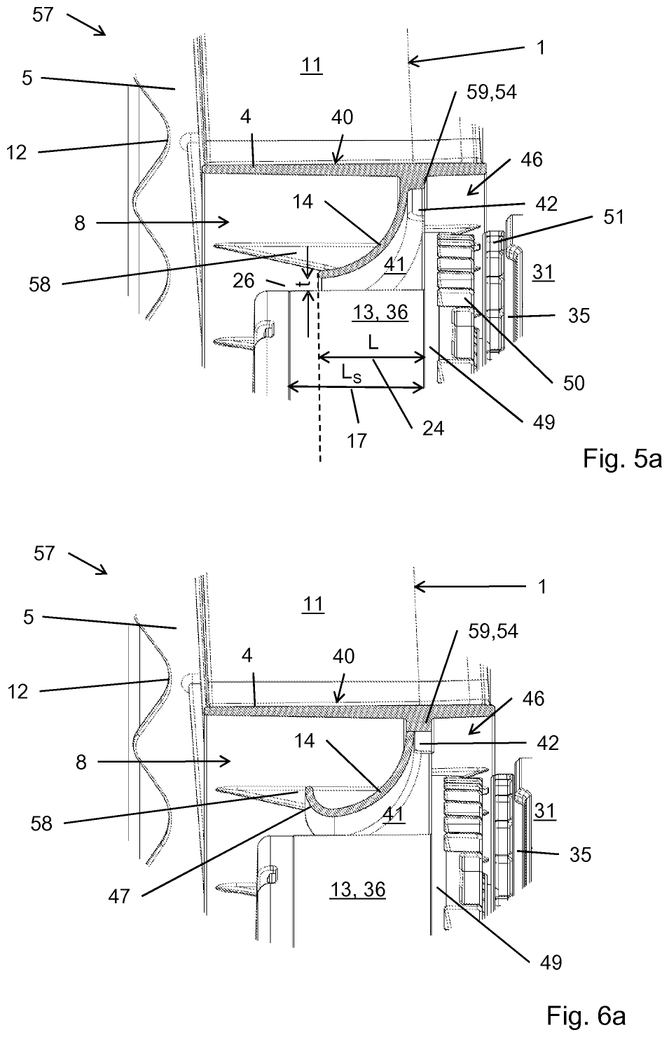

Due to the design of the cooling structure 40 having the hub ring 4 in the hub pot 8, there is sufficient space in the radial direction present at the stator-proximal end between the external contour of the stator 36, or of the electronics pot 13. In particular, the external diameter of the hub ring 4, or of the cooling structure DN 27 (see FIG. 4a or 5), is at least 15%, advantageously 30%, larger than the external diameter D: 63 of the electronics pot 13 (see FIG. 5) in the region of the cable connectors 53 (see also FIG. 4a). This is advantageous and enables the required electrical cables to be easily connected to the stator 36, or the electronics pot 13, of the motor 34 during assembling.

FIG. 2 shows in a perspective view, when viewed from the inflow side, the fan 57 according to FIG. 1. Additionally and supplementarily to FIG. 1, the impeller 19 having its vanes 22 fastened integrally to a hub 31 can be better seen. A hub cap 37 is fastened to the hub 31 of the impeller 22, advantageously latched by way of latching hooks. The hub cap 37, interacting with the hub 37, ensures a fluidically favorable contour in the hub region of the impeller 19, which is advantageous for a high efficiency and low noise. The rotor 35 of the motor 34 can be seen within the hub cap 37, the latter having a large opening in a radially inner region. Positive cooling of the rotor 35 of the motor 34 is guaranteed by this design of the hub cap 37 having an inner opening. During the operation of the fan 57, the impeller 19, which is driven by the rotor 35 of the motor 34 to which said impeller 19 is fastened, rotates in the rotating direction 32, here in the clockwise direction, for instance. As a result, a conveyed medium, often air, is conveyed by the fan 57 from the inflow side, visible here, in the flow direction through the axial regions inlet nozzle 9, impeller region 29 and diffusor 10 to the outflow side lying axially opposite the inflow side. In particular, energy is transferred to the conveyed media flow conveyed in such a way, this being able to be measured in the form of an increase in pressure, in particular an increase in total pressure and/or an increase in static pressure. The conveyed media flow is divided into two main portions downstream of the impeller, a first portion flowing through the outer flow region 6, and a second portion flowing through the inner flow region 7.

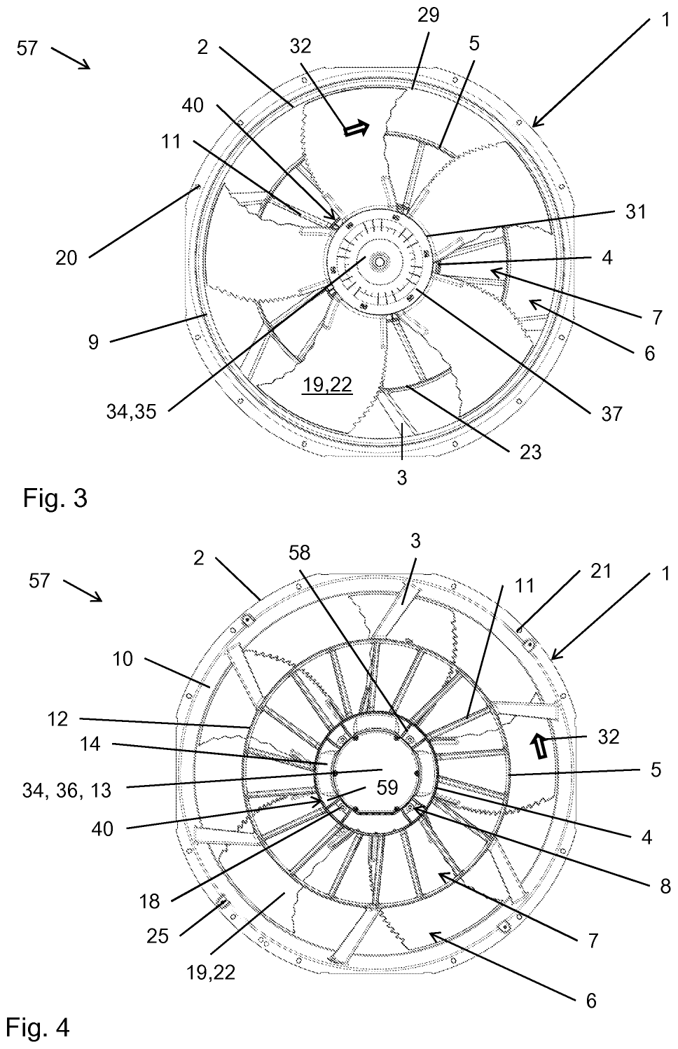

FIG. 3 shows in a flat axial top view, when viewed from the inflow side, the fan 57 having the structural streamer unit 1 from FIGS. 1 and 2. Additionally to the descriptions pertaining to FIGS. 1 and 2, it can be seen here that the hub 4 of the streamer unit 1, and thus most particularly the cooling structure 40, project radially beyond the hub 37 of the impeller 19. This is advantageous for the functional mode of the cooling structure 40 for cooling the motor 34, or its stator 36, or its electronics pot 13, respectively. For example, the flow conveyed by the impeller 19 can flow downstream of the impeller 19, in the radial region between the external radius of the impeller hub 37 and the internal radius of the hub 4, the latter forming the outer periphery of the cooling structure 40, into the cooling structure 40 and improve the cooling of the motor.

FIG. 4 shows in an axial top view, and when viewed from the outflow side, the fan 57 having the cooling structure 40, the latter here being integrated into a structural streamer unit 1, according to FIGS. 1 to 3. Additionally to the explanations pertaining to FIGS. 1 to 3, the outer flow region 6, which is penetrated by the strut wings 3, and the inner flow region 7 having the inner guide vanes 11, can be readily seen. During the operation of the fan 57, the impeller 22 having the vanes 19 rotates in a counter-clockwise direction of rotation 32 about the fan axis in this view. The motor 34 in the cooling structure 40, in the stator-proximal receptacle region 8, also referred to as the hub pot 8, is attached to a flange 54 of the cooling structure 40, presently also functioning as a motor support flange 59, by means of fastening provisions 18, in an embodiment, screws. During the operation of the fan 57, the cooling structure 40 increases the dissipation of heat from the motor 36, in particular from its stator 36, and furthermore particularly from its electronics pot 13, and in terms of cooling the motor interacts in this way as a functional unit in combination with the electric motor 34, or the stator 26, or the electronics pot 13.

The diffusor region 10 widens from the region 29 for the impeller 19 (see also FIG. 1) toward the outflow-side periphery of the housing 2. The intermediate ring 5, proceeding from the impeller 19, also widens slightly toward its outflow-side periphery 12 (FIG. 5). As a result, the inner flow region 7 as well as the outer flow region 6 in the exemplary embodiment are designed in the manner of a diffusor, i.e. widening in the flow direction. This is advantageous with a view to a high recuperation of pressure downstream of the impeller 19, and thus with a view to a high static efficiency of the fan 57. The static increase in pressure is particularly advantageous in the flow path between the impeller 19 and the exit from the fan 57, in particular also with a view to a potential advantageous functional mode of the cooling structure 40 for cooling the motor 34, or the stator 36, or the electronics pot 13, respectively.

Specifically as a result of the pressure differential, thus the static pressure which in this instance is higher at the outflow-side end (in terms of the fan main flow) of the cooling structure 40 in comparison to the inflow-side end of the latter (in terms of the fan main flow), a cooling flow counter to the main flow direction is induced within the cooling structure 40 in the stator-proximal inner receptacle region 8. This cooling flow additionally cools the motor 34, or the stator 36, or the electronics pot 13, respectively, in that said cooling flow flows past those. Said cooling flow can flow in the direction of the inflow side between the motor 34 and the cooling structure 40, presently additionally directed by the cooling flow guides 14, through passages in the region of the cooling structure flange 54 up to the opposite side of the cooling structure flange 54 (see in particular FIGS. 5, 5a).

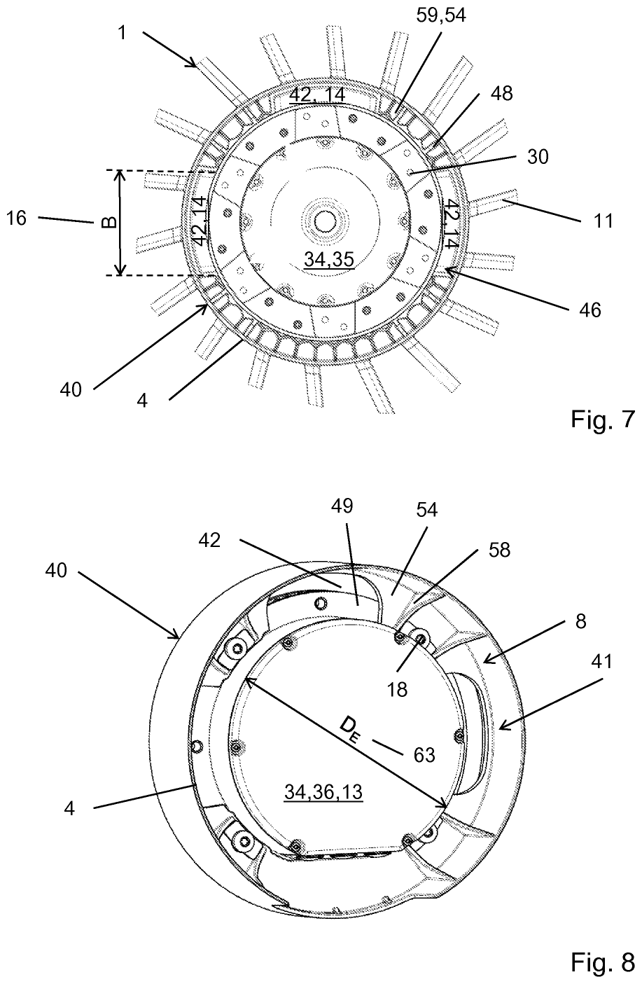

FIG. 4a is a detailed view from FIG. 4 in the region of the cooling structure 40, wherein the width dimension B 16 is schematically plotted. B 16 herein describes the width of a cooling flow guide 14, thus the extent of the latter in a direction approximately transverse to the fan axis, thus approximately in the circumferential direction. Since a cooling passage 42—not visible here—through the cooling structure flange 54, having a similar extent in the circumferential direction, corresponds to the cooling flow guide 16 (see in particular FIG. 5a, FIG. 7), B can in particular also be interpreted as the width of the cooling passage 42. Provided in the exemplary embodiment are three cooling passages 42 having assigned cooling guides 14, which are distributed across the circumference. As a consequence of this configuration, the three regions on the radially outwardly directed surface of the electronics pot 13 of the motor 34, which lie radially directly opposite the cooling flow guides 14, are particularly positively cooled, because a cooling flow medium at a relatively high flow velocity and/or flow turbulence is directed close to the corresponding surfaces due to the cooling flow guides 14 and the cooling passages 42. These are advantageously regions where positive cooling is particularly important, for example specifically in relation to power-electronic components disposed in the interior of the electronics pot, which components generate a particularly large amount of heat, such as an output stage (IGBT) or an input stage, for example, or also in relation to components which are particularly sensitive to temperature. When using cooling flow guides 14, the width B 16 of the latter, or the width B 16 of the cooling passages 42, is preferably in the range from 10% to 45% of the diameter DN 27 of the stator-proximal receptacle region 8 of the cooling structure 40.

Illustrated in a lateral view and in a sectional view through a plane through the axis in FIG. 5 is the fan 57 having a structural streamer unit 1 according to FIGS. 1 to 4, having schematically plotted dimensions in the region of the cooling structure 40, of the impeller hub 31 and of the inlet nozzle 9. Additionally to the respective figures, the contour of the hub cap 37, which is aerodynamically favorable, radiused and transitions toward the hub 31 of the impeller 19 by way of a consistent tangent and is attached in the region of the hub of the impeller 19, can be seen.

The motor 34, including the stator 36 and the rotor 35, is not illustrated in a sectional view. The stator 36, here also comprising the electronics pot 13, is fastened to the cooling structure flange 54, also functioning as the motor fastening flange 59, in the interior of the stator-proximal receptacle region 8 of the cooling structure 40 which is presently integrated into a structural streamer unit 1. Fastened to the rotor 35 of the motor 34 is the impeller 19 with its hub 31 and vanes 22, the radially outer ends thereof advantageously having a special contour, i.e. winglets 38, wherein a small radial spacing is formed, and a flow gap is present, between the impeller vanes 22 having the winglets 38 and the impeller region 29 of the housing 2.

The fan 57 is of a particularly compact radial design. This means that the entry diameter Da 45 of the inlet nozzle 9 is relatively small in comparison to the internal diameter Di 44, the ratio advantageously being Da/Di<1.1. This also enables a relatively small extent e 43 of the streamer unit transversely to the fan axis (the extent e 43 can in particular be the length of a side of a square contour which extends transversely to the fan axis and within which the structural streamer unit 1, and thus the fan 57, can be inserted). Advantageously, e/Di<1.2. As a result, the fan 57, in terms of its internal diameter Di 44 and thus also in terms of the diameter of its impeller 19, when viewed transversely to its axis, occupies a relatively particularly small installation space. Conversely, in the case of a predefined installation space, a fan 57 having a particularly large internal diameter Di 44 and thus a particularly large external diameter of the impeller 19 can be used, this being potentially advantageous in acoustic terms at a predefined operating point.

As a result of the relatively large internal diameter Di relative to the outer extent e 43 which defines the radial installation space, a large flow cross section is fundamentally available, this being very advantageous with a view to lower acoustics and a high static efficiency of the fan 57 at a given operating point. As a result, i.e. as a result of the presence of a relatively large flow cross section of the fan within the housing 2, this also facilitates the implementation of a larger diameter D_{N} 27 of the cooling structure 40 in comparison to the diameter D_{L} 28 of the hub 31 of the impeller 19, even without any excessive impediments due to the blockage effect, this being advantageous for the functional mode of the cooling structure 40, as has already been described by means of FIG. 3. D_{N}/D_{L} is, in an embodiment, in a range from 115% to 135%, and in another embodiment is approximately 115%. A sub-flow acting for cooling can flow from the inflow side into the cooling structure 40 in the radial region between the impeller hub 31 and the cooling structure 40, or conversely exit counter to the main flow direction of the fan between the impeller hub 31 and the cooling structure, depending on the operating state of the fan 57.

FIG. 5a is a detailed view from FIG. 5 in the region of the cooling structure 40, wherein further characteristic dimensions are schematically plotted. The flow path within the cooling structure 40 can be readily seen in this detailed illustration. The cooling structure 40 within the hub ring 4 in the exemplary embodiment has a rotor-proximal receptacle region 46 and a stator-proximal receptacle region 8 here. In a first operating state, the flow can flow from the rotor side to the stator side through the cooling structure 40 in the same direction as the main flow of the fan.

In a second operating state, the flow can flow through the cooling structure 40 from the stator side to the rotor side counter to the direction of the main flow of the fan. The second operating state is present in particular when the main flow of the fan is imparted a significant increase in the static pressure when flowing through the cooling structure 40, i.e. presently in particular when the streamer wheel with the inner streamer vanes 11 is passed through by the flow, or when the inner and outer flow regions 7 and 6 widening in the manner of a diffusor in the flow direction are passed through by the flow (see FIG. 4). As a result of the pressure differential thus created, a flow through the cooling structure 40 along the motor 34, or the stator 36, or the electronics pot 13, respectively, counter to the main flow direction of the fan, presently from the stator 36 in the direction of the rotor 14, is caused. In this way, a very efficient additional cooling of the motor 34, or of the stator 36, or of the electronics pot 13, respectively, can be achieved in particular in the operating state 2.

The flow path through the cooling structure here runs (in this sequence or vice versa) from the outflowing main flow of the fan through the stator-proximal receptacle region 8, then between the electronics pot 13 and a cooling flow guide 14 along a cooling flow duct 41, presently delimited by the cooling flow guide 14, to a cooling passage 42 in the region of the cooling structure flange 54 into the rotor-proximal receptacle region 46, so as to ultimately exit the cooling structure 40 there, and to mix with the main flow of the fan. After passing through the cooling passages 42, the fluid can optionally also flow through a cooling system integrated into the motor 34, for example as in the present exemplary embodiment, where the integrated motor cooling system comprises in particular stator cooling ribs 50 and a rotor cooling fan wheel 51. The embodiment of a cooling flow guide 14 integrated into the cooling structure 40, and thus the formation of the corresponding shape of the cooling flow duct 41 between the cooling flow guide 14 and the stator 36, or the electronics pot 13, respectively, is particularly advantageous for the dissipation of heat, because a flow at a high velocity and/or with a high turbulence is directed in a targeted manner close to the surface of the motor to be cooled. For this purpose, in the assembled state, at least one region is embodied with a small gap along the cooling flow duct 41, thus a minor spacing t 26 between the cooling flow guide 14 and the stator 36, or the electronics pot 30, respectively. This gap width, or this smallest spacing t 26, is, in an embodiment, between 2 mm and 15 mm, and approximately 5 mm in another embodiment.

The overlapping length L 24 between the cooling flow guide 14 and the stator 36, or the electronics pot 13, respectively, or in other words the axial length L 24 of the cooling flow guide 14, is of a sufficient size, for example is at least 50% of the axial length Ls 17 of the electronics pot 13, presently measured from the attachment plane of the stator flange 49 to an electronics cover, if present.

It is to be noted that embodiments without a cooling flow guide 14 are also conceivable, see FIGS. 8 to 10, for example. The formation of a cooling flow guide 14, and thus of a cooling flow duct 41, having a very minor spacing from the external wall of the stator 36, or of the electronic pot 13, respectively, in terms of the centerline thereof when viewed in a sectional view, is however particularly advantageous, in an embodiment. However, at least the embodiment of a cooling passage 42 in the axial region of the cooling structure flange 54 is particularly relevant in order to achieve the described flow through the cooling structure 40 in interaction with the electric motor 34 during the operation of the fan.

In the exemplary embodiment, the cooling structure 40 is designed in such a way that it can be demolded integrally in one piece, including the cooling flow guide 14, without any undercuts from a molding tool, in particular from a plastic injection-molding tool, specifically by way of two shape-imparting tool parts which are demolded from the component in the axial direction to the component, one of those toward the right in the direction of the fan inflow side in the view, and one of those toward the left in the direction of the fan outflow side in the view. As a result, the narrowest spot is located between the cooling flow guide 14 and the stator 36, or the electronics pot 13, approximately on the periphery of the cooling flow guide 14 that faces away from the stator flange 49. This is particular advantageous, in an embodiment, with a view to an economical production of the corresponding tool, and for economically manufacturing the components (cooling structures 40) in mass production.

FIG. 6a is a detailed view similar to FIG. 5a, in the region of a cooling structure 40 of a different embodiment of a cooling structure 40. As opposed to the embodiment according to FIG. 5a, the cooling flow guide 14 is of a different design. The narrowest point between the cooling flow guide 14 and the stator 36, or the electronics pot 13, is no longer located on the periphery of the cooling flow guide 14 that faces away from the stator flange 49, but is displaced farther in the direction of the stator flange 49.

For the operating state 2, in which the cooling flow within the cooling structure 40 flows from the fan outflow side to the fan inflow side (in the view from the left to the right), a special inflow region 47 is formed in the cooling flow duct 41 formed by the cooling flow guide 14, so that the cooling flow duct 41, proceeding from the stator-proximal periphery of the cooling flow guide 14, runs toward the stator flange 49 so as to initially converge up to a narrowest point, before said cooling fluid duct 41 in the further course diverges in the direction of the stator flange 49 again. This can be particularly advantageous, in an embodiment, for the flow velocities and/or the turbulence in the cooling flow duct 41, and thus for the cooling of the stator 36, or of the electronics pot 13, respectively. However, if the cooling flow guide 14 is produced so as to be integral to the cooling structure 40, such an embodiment requires more complex demolding from a molding tool, in particular if said embodiment is no longer free of undercuts in terms of the direction of the fan axis, as in the embodiment shown.

Shown in FIG. 7 in a flat axial top view, when viewed from the inflow side and in a fragment, is a cooling structure 40 according to the present disclosure, having guide elements 11 integrated externally thereon, and having an installed electric motor 34, for example according to embodiments according to FIGS. 1 to 5. The impeller is not illustrated here. The view here is from the fan inflow side into the rotor-proximal receptacle region 46 of the cooling structure 40. To be seen is the rotor 35 of the motor 34, which has fastening provisions 30 for fastening an impeller. Three cooling passages 42, and the cooling flow guides 14 extending therebehind and integrated into the cooling structure 40, can be seen radially outside the rotor 35, still within the cooling structure 40 and the hub ring 4 externally delimiting the latter. As has already been described by means of FIG. 4a, the cooling passages 42 have a characteristic width B 16, measured approximately in the circumferential direction, or transversely to the fan axis. Reinforcement ribs, presently the rotor-proximal reinforcement ribs 48, for reinforcing the connection between the hub ring 4 and the motor support flange 49, are also formed in the rotor-proximal receptacle region 46, said reinforcement ribs being advantageously integrated into the cooling structure 40 so as to be integral to the latter, like the cooling structure flange 54 embodied as the motor support flange 59.

FIG. 8 shows in a perspective view, when viewed from the outflow side, a further embodiment of a cooling structure 40 for a fan having installed therein an electric motor 34, of which the stator 36, or the electronics pot 13, can be seen. The cooling structure 40 has the hub ring 4 which delimits the latter radially toward the outside, and has a flange 54 by way of which said cooling structure 40 is connected to the flange 49 of the stator 36. This embodiment of a cooling structure 40 is not integrated into any further fan components, and can in particular also not be used as a structural component; this means that other components, for example support struts, would have to take over the connection of the motor to a housing or an apparatus or similar in the assembled state. Like the cooling structure 40, such support struts or similar can be fastened to the flange 49 of the stator, either to attachment points which are offset from the attachment points of the cooling structure flange 54 in the circumferential direction, or are axially between the cooling structure 40, or the flange 54 thereof and the stator flange 49, with the aid of fastening provisions 18, in particular threaded connections.

It is essential that in the assembled state, also with a suspension, cooling passages 42 which enable a flow through the cooling structure 40 in the axial direction, from a rotor side to a stator side, or vice versa, are formed. Such a cooling flow promotes the dissipation of heat from the motor 34, or from its stator 36, or from its electronics pot 30, respectively. In the exemplary embodiment, no further cooling flow guides which guide a cooling flow particularly close to the stator 36 are provided. It goes without saying that this is also advantageously conceivable in the case of non-structural cooling structures 40, or cooling structures 40 which are not integrated into further fan components.

It is to be noted at this point that, in particular in the operating state 2, when the cooling flow within the cooling structure 40 is directed counter to the main flow of the fan, the effective conveyed volumetric flow of the fan is reduced by the returning cooling flow as a result, and the overall efficiency of the fan decreases. Therefore, the size, or the cross section, of the cooling passages 42 is advantageously carefully chosen so that a positive cooling effect is achieved and the overall efficiency of the fan is simultaneously not excessively compromised. When a cooling flow guide 14 is formed, such as in the embodiment according to FIGS. 1 to 5, for example, the size of the cooling flow can also be readily controlled by way of the cooling flow guide 14 and the smallest spacing of the latter from the stator 36, or from the electronics pot 13, of the motor 34, respectively.

In an embodiment without a cooling flow guide such as according to FIG. 8, this has to be controlled by way of a careful choice of the open cross section of the cooling passages 42 in the state assembled with the motor 34. In the configuration without cooling flow guides, an open overall cross section in the region of the passages 42 of not more than 10% of the reference cross section of the electronics housing 13 is advantageous, this being able to be defined by way of the external diameter DE 63 of the latter using π/4*D_{E}*D_{E}. This value applies very generally, also to embodied cooling flow guides 14, if the narrowest cross section in the flow path, or in the cooling flow duct 41 of the cooling flow through the cooling structure 40 in the assembled state with the motor 34 is used for the open overall cross section, this narrowest cross section in embodiments having cooling flow guides 14 such as, for example in FIGS. 1 to 7, typically being provided in the region of the smallest spacing of the cooling flow guides 14 from the stator 36 of the motor 34, or from the electronics pot 13, respectively.

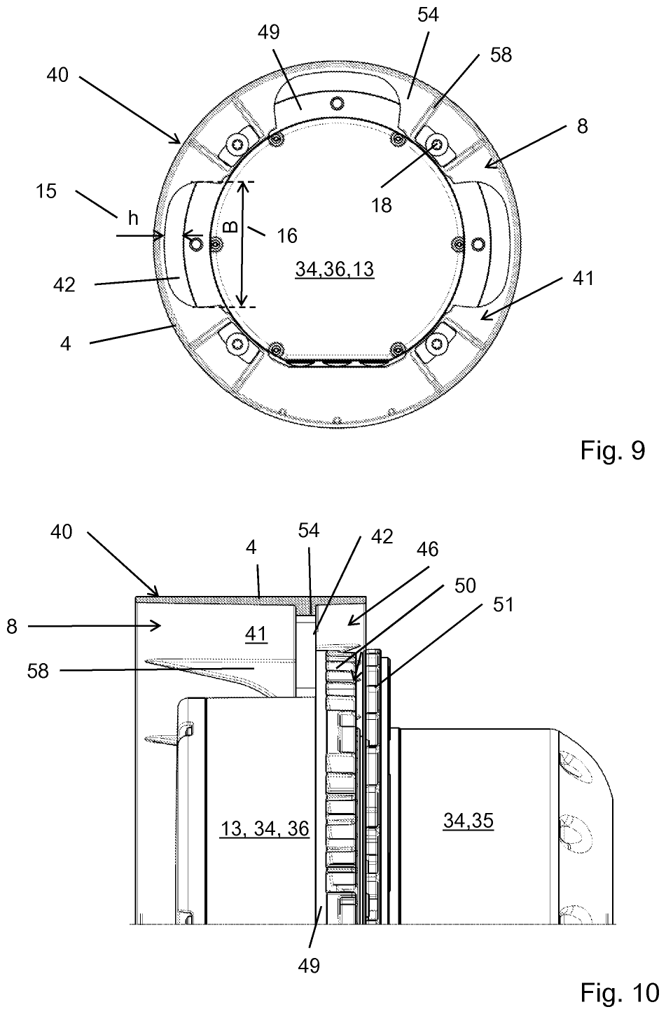

Illustrated in FIG. 9 in a flat axial top view, when viewed from the outflow side, is the cooling structure 40 having the motor 34 according to FIG. 8. In addition to FIG. 8, the width B 16 approximately in the circumferential direction of a cooling passage 42, in the state assembled with the motor 34, is plotted here, similar to FIG. 7. In particular in embodiments without cooling flow guides 14, it is also conceivable to embody a significantly larger number of cooling passages 42, but with a smaller width B, for example up to 60 cooling passages. The cooling passages 42 also have the open height h 15 in the radial direction, which conjointly with the width B characterizes the open cross-sectional area of a single cooling passage 42, and in this instance the open overall cross section is the sum of all open cross-sectional areas of all cooling passages 42.

Illustrated in FIG. 10 in a lateral view, and in a sectional view through a plane through the axis, is the cooling structure 40 having the motor 34 according to FIGS. 8 and 9. The path of a potential cooling flow within the cooling structure 40, or the hub ring 4 of the latter, through a cooling flow duct 41 can be readily traced. Here too, a stator-proximal receptacle region 8 and a rotor-proximal receptacle region 46 are formed within the cooling structure 40, separated in the axial direction by the cooling structure flange 54, on the one hand, wherein the cooling passages 42 establish a fluidic connection. In this way, cooling medium within the cooling structure 40 can flow either from the stator 36 in the direction of the rotor 35, or from the stator-proximal receptacle region 8 through the cooling passages 42 to the rotor-proximal receptacle region 46, or vice versa, depending on the prevailing external flow or pressure conditions.

In this context, a convective cooling system integrated on the motor 34 can also play a part. Like the motors in the embodiments according to FIGS. 1 to 7, the motor shown has a dedicated integrated cooling system having a rotating cooling fan wheel 51 which is fastened to the rotor 35, and heat-dissipating cooling ribs 50 on the stator 36, or its flange 49, respectively. This cooling system ensures a basic dissipation of heat on the motor 34, which however can be significantly increased by the effect of the cooling structure 40. The cooling flow within the cooling structure 40 can in any case be caused or facilitated also by the cooling wheel 51 of the basic cooling system integrated into the motor 34. However, the cooling flow is particularly advantageously, in an embodiment, caused or reinforced directly or indirectly by an impeller and/or a vane wheel and/or a diffusor of a fan.

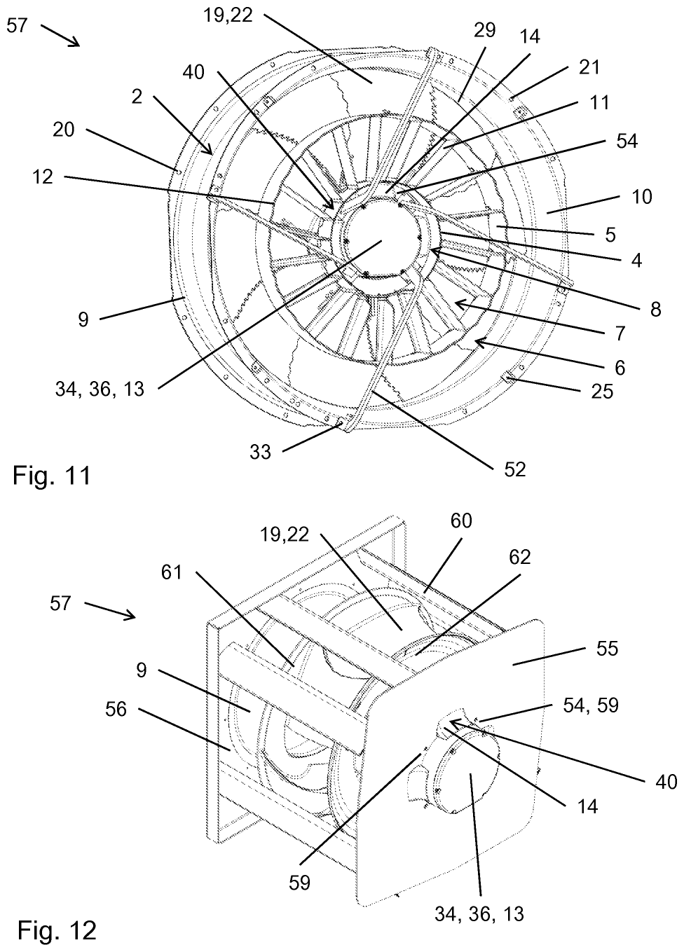

FIG. 11 shows in a perspective view, when viewed from the outflow side, a further embodiment of a fan 57 having a cooling structure 40 according to the present disclosure, which is integrated into an inner streamer assembly including in particular of an intermediate ring 5, a hub ring 4 and guide elements 11, wherein the supporting function is assumed by a metallic strut suspension 52. In this way, no structural streamer unit is embodied, and the cooling structure 40 also has only a partially structural function, specifically for the inner streamer assembly. The housing 2, designed similarly to the housing in the embodiment according to FIGS. 1 to 7, but as a separate component, is connected to the motor 34, or its stator 36, respectively, by way of the metallic strut assembly 52. In terms of the construction of the cooling structure 40 and the associated description of the functional mode, reference can be made to preceding FIGS. 1 to 7 and the relevant description. Cooling passages 42 only have the effective cross section which in the assembled state enables a flow through the cooling structure flange 54 within the cooling structure 40 from the stator side to the rotor side, or vice versa, respectively. For this reason, a potential covering effect of the strut assembly 52 in terms of the cooling passages 42 is to be taken into account, which in the assembled state may reduce the effective cross-section of the cooling passages 42.

Similar embodiments having structural metallic strut assemblies 52 are also conceivable without an inner streamer wheel, similar to the cooling structures according to FIGS. 8 to 10. Also, it is readily and very advantageously conceivable to implement embodiments having structural metallic strut assemblies 52 and cooling flow guides similar to the cooling flow guides 14 according to the embodiment according to FIGS. 1 to 7, which conjointly with the stator 36 of the motor 34, or the electronics pot 13, respectively, define a cooling flow duct 41 having a narrow flow cross section between the cooling flow guides 14 and the external wall of the stator 36, or of the electronics pot 13, respectively, within the cooling structure 40.

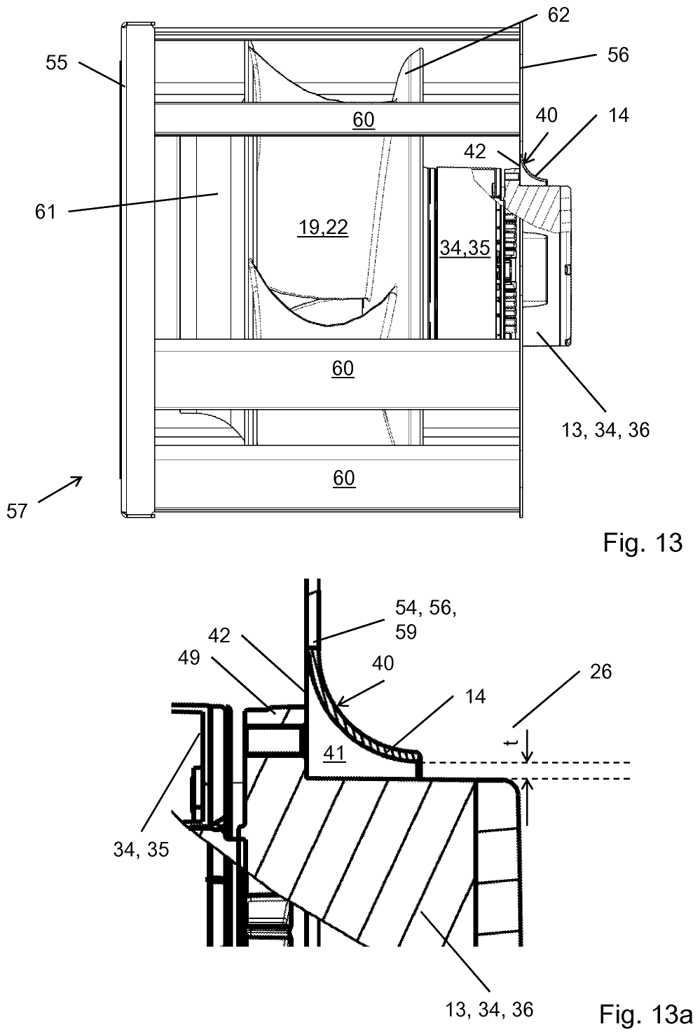

Illustrated in FIG. 12 in a perspective view, when viewed from the outflow side, is a further embodiment of a cooling structure 40 integrated on a fan 57 of a radial construction type. The fan 57 has an impeller 19 of a radial construction type, which includes substantially a base disk 62, a cover disk 61 and vanes 22 extending therebetween. The cover disk 61 has a central opening into which the inlet nozzle 9 protrudes. The inlet nozzle 9 is fastened to a nozzle plate 56. The impeller 19 in turn is fastened to the rotor 35 of a motor 36 (see also FIG. 13), the stator 36 of the latter being attached to a motor support plate 55. Support struts 60 hold the motor support plate 55 on the nozzle plate 56. Substantially the entirety including the nozzle plate 56, the support struts 60 and the motor support plate 55 is referred to as the support module of the fan 57. The fan 57 on its nozzle plate 56 can be fastened to a superordinate apparatus or an air engineering system, and thus be supported and operated.

During the operation of the fan 57, the motor 34 by way of its rotor 35 drives the impeller 19, a conveyed media flow being generated as a consequence of the rotating movement of the latter. The conveyed media flow enters the impeller 19 through the inlet nozzle 9, flows out radially toward the outside and flows past the support struts 60 out of the fan 57. When flowing through the fan 57, energy is transmitted to the conveyed media flow, this being noticeable by an increase in the total pressure and/or in the static pressure. In the exemplary embodiment, the support struts 60 are designed in an aerodynamically favorable manner, so as to achieve a high efficiency and low noise values; in particular, said support struts 60 are designed in the cross section so as to be similar to the cross section of an airfoil, thus rather elongate in the flow direction with a radiused inflow edge and a rather thin trailing edge.

When viewed in the radial direction, thus viewed transversely to the axis, the motor support plate 55 protrudes beyond the impeller 19, this being advantageous for the static efficiency of the fan 57. As a result, a negative pressure is created in an inner region close to the axis and close to the motor 34, in relation to a static pressure level at the outlet of the fan 57 on the outflow side of the support struts 60. Consequently, the static pressure within the motor support plate 55, on the impeller side, is significantly lower than on the opposite external side of the motor support plate 55, outside the fan 57 or the support module, respectively.

The cooling structure 40 is now attached to the motor support plate 40, or integrated into the latter, in the region of the stator 36 of motor 34. The external diameter of the cooling structure 40 here can be defined by the external diameter of cooling passages 42, or of cooling flow guides 14, respectively (see FIG. 13a). As a result of the pressure differential described, a cooling flow from outside the support module flows between the stator 36, or the electronics pot 13, being directed by the cooling flow guides 14 in the axial direction through the motor support plate 55 having the integrated cooling structure flange 54, or the motor fastening flange 59, into the internal region of the support module. In the process, additional heat is dissipated from the motor 34, or from the stator 36, or from the electronics pot 13, respectively, and the cooling of the motor 34 is thus improved.

FIG. 13 shows in a lateral view, and in a partially sectional view in a region close to the cooling structure 40 through a plane through the axis, the fan 57 having the cooling structure 40 from FIG. 12. FIG. 13a is a detailed view of FIG. 13 in the region of the cooling structure 40, wherein a characteristic dimension is additionally schematically plotted. The cooling structure 40 overall can be produced integrally on the motor support plate 59, in particular when the motor support plate 56 is produced as a casting, advantageously, in an embodiment, by a plastic injection-molding process. Also attached to the motor support plate 56 is the cooling structure flange 54, embodied as an integral or separate component and as a fastening flange 59 for fastening the motor 34. If the cooling structure flange 54, or the fastening flange 59, respectively, is embodied on a separate component in relation to the motor support plate 56, potentially while implementing an axial offset between the motor support plate 56 and the screwing plane on the stator flange 49, the cooling structure 40 can also be integrated on this separate part.

The cooling structure 40 can also be fastened to a motor support plate 56 in the form of a plurality of separate components which represent the cooling flow guides 14, for example. As can be seen in particular in FIG. 13a, there is at least one cooling passage 42 which establishes a fluidic connection between a stator side outside the cooling structure flange 54, or of the fastening flange 54 in terms of the support module, respectively, and a rotor side within the cooling structure flange 54, or of the fastening flange 59 in terms of the support module, respectively.

As a result of the pressure differential induced by the fan 57 during operation, a cooling flow within the cooling structure 40 flows between the cooling flow guide 14 and the stator 36 of the motor 34, or the electronics pot 13, respectively, at a rather high flow velocity and entrains waste heat from the motor 34, or it stator 36, or the electronics pot 13, respectively. The cooling flow subsequently flows through the cooling passages 42 into the interior of the support module, where said cooling flow is ejected radially outward.

Similar to FIG. 5a, the minimum spacing t of the cooling flow guide 14 from the external wall of the stator 36, or of the electronics pot 13, respectively, is illustrated. Favorable values for t have already been specified according to the description of FIG. 5a. The cooling flow duct 41, which is formed by the cooling structure 40, or the cooling flow guide 14, respectively, can be characterized by an imaginary centerline when viewed in the sectional view shown. Moving away from the stator flange 49 in the direction of the stator side, or of the electronics housing side, respectively, thus presently toward the right, this centerline has a profile toward the fan axis, thus from larger radii to smaller radii in terms of the fan axis. Proceeding from the stator flange, the cooling flow guide 14 in particular also has such a profile. The design of a cooling structure 40 having such a cooling flow guide 14 is generally advantageous. The cooling flow is guided radially outside past the stator flange 49, without a passage having to be created on the stator flange 49; however, the external wall of the stator 36, or of the electronics pot 13, respectively, which lies radially farther inside is in particular cooled.

### LIST OF REFERENCE SIGNS

1 Structural streamer unit
2 Housing of the streamer unit
3 Strut wing
4 Hub ring, outer ring of the cooling structure
5 Intermediate ring of the streamer unit, or of the diffusor
6 Outer flow region
7 Inner flow region
8 Stator-proximal receptacle region within the hub ring, hub pot
9 Inlet nozzle
10 Outer diffusor wall
11 Inner guide element, guide vane
12 Outflow edge of the intermediate ring
13 Stator pot, electronics housing
14 Cooling flow guide
15 Height h of the cooling flow breakthrough
16 Width B of the cooling flow guide/of the cooling passage
17 Length Ls of the electronics pot
18 Fastening provision in the receptacle region
19 Impeller
20 Inflow-side fastening provision of the streamer unit on superordinate system
21 Outflow-side fastening provision of the streamer unit on superordinate system
22 Vane of the impeller
23 Inflow-side periphery of the intermediate ring of the streamer unit
24 Overlapping length L Cooling flow guide—stator pot
25 Fastening provision for protective mesh on outflow side
26 Spacing t of cooling flow guide in radial direction from stator (gap height)
27 Diameter D_{N} of the receptacle region in the hub/of the hub pot
28 Diameter D_{L} of the impeller hub
29 Region for an impeller
30 Fastening provision for motor on the impeller
31 Hub of the impeller
32 Rotating direction of the impeller
33 Fastening of the suspension on the housing
34 Motor
35 Rotor of the motor
36 Stator of the motor
37 Hub cap
38 Winglets of the impeller vanes
39 Not allocated
40 Cooling structure
41 Cooling flow duct
42 Cooling passage in the region of the fastening flange
43 Extent e of the streamer unit transversely to the fan axis
44 Internal diameter Di of the housing of the streamer assembly in the region of the impeller
45 External diameter Da on the outer beginning of the curvature of the inlet nozzle 9
46 Rotor-proximal receptacle region with the hub ring
47 Inflow region of the cooling flow guide
48 Reinforcement ribs in the rotor-proximal receptacle region
49 Flange of the stator
50 Cooling ribs on the stator
51 Cooling fan wheel on the rotor
52 Suspension
53 Cable connectors on the stator or the electronics housing of the motor
54 Flange of the cooling structure
55 Support plate
56 Nozzle plate
57 Fan, axial fan
58 Reinforcement ribs in the receptacle region for the motor
59 Fastening flange for motor
60 Support struts
61 Cover disk
62 Base disk
63 External diameter D_{E} of the electronics housing

1. A fan having an impeller and an electric motor, wherein the electric motor includes a stator, a rotor and optionally an electronics pot, comprising:
a cooling structure is formed or provided on the external wall radially outside at least one of the stator and the electronics pot, which cooling structure forms a flow path for a fluid by way of which a flow is induced due to a pressure differential generated by the operation of the fan, wherein the flow dissipates heat from at least one of the electric motor, the stator, and the electronics pot.

2. The fan as claimed in claim 1, wherein the cooling structure is not formed by functionally relevant components of the motor and does not lead through the latter.

3. The fan as claimed in claim 1, wherein the cooling structure is formed by a separate cooling unit which is disposed on or fastened to a stator flange.

4. The fan as claimed in claim 1, wherein the separate cooling unit is able to be retrofitted.

5. The fan as claimed in claim 1, wherein the cooling structure is attached to or in a motor support plate of a radial or diagonal fan, or is integrated into the motor support plate.

6. The fan as claimed in claim 1, further comprising a streamer assembly having a streamer wheel, wherein the cooling structure is assigned to the streamer wheel.

7. The fan as claimed in claim 6, wherein the streamer assembly has a structural function for the motor.

8. The fan as claimed in claim 1, wherein, in the state assembled with the motor, a flow path for the cooling flow extending within the cooling structure from the rotor side to the stator side or form the stator side to the rotor side is formed by cooling passages through a cooling structure flange in the region of a motor suspension plane on the stator of the motor.

9. The fan as claimed in claim 1, wherein the flow path leads past radially outside a stator flange.

10. The fan as claimed in claim 1, wherein a narrowest flow region for a cooling flow in the flow path is formed between an external wall of the stator of the motor, or of the electronics pot, respectively, and the cooling structure, or a cooling flow guide, respectively, through which narrowest flow region the cooling flow is directed past close to the external wall of the stator, or of the electronics pot, respectively, at a high velocity.

11. The fan as claimed in claim 1, wherein the flow path, or the centerline of the latter, for a cooling flow, or the cooling flow guide, runs from a stator flange in the direction of a stator side, or an electronics housing side, toward a fan axis, thus from larger to smaller radial positions, so as to guide the cooling flow close to a wall of the stator, or of the electronics pot.

12. A cooling structure for a fan having a fan hub and an electric motor with a stator, having the features relating to the cooling structure as claimed in claim 1, wherein the cooling structure is disposed between the fan hub and the stator
